(19) United States
(12) Patent Application Publication
(10) Pub. No.: US 2024/0336237 A1
(43) Pub. Date: Oct. 10, 2024

(54) HOT SWAP BATTERY CARRIER SYSTEM AND METHOD

(71) Applicants: High Desert Racing Products, LLC, Reno, NV (US); Hypercraft Inc., Provo, UT (US)

(72) Inventors: Kory Negrich, Provo, UT (US); Jacob Hawksworth, Provo, UT (US)

(21) Appl. No.: 18/627,325

(22) Filed: Apr. 4, 2024

Related U.S. Application Data
(60) Provisional application No. 63/456,934, filed on Apr. 4, 2023.

(51) Int. Cl. B60S 5/06; B60R 16/033

(52) U.S. Cl. CPC B60S 5/06; B60R 16/033

(57) ABSTRACT

A hot swap battery carrier system comprising a receiver configured to be installed in a vehicle; a carrier including a battery pack; a slide mechanism configured to enable the carrier including the battery pack to slide into and out of the receiver.

### CROSS-REFERENCE TO RELATED APPLICATION

This application claims the benefit of U.S. Provisional Patent Application No. 63/456,934, filed Apr. 4, 2023, under 35 U.S.C. 119 and is incorporated herein in its entirety.

### FIELD OF THE INVENTION

The present invention relates energy storage hot swapping systems and methods.

### BACKGROUND OF THE INVENTION

Swapping high voltage battery packs requires a mounting system that allows batteries to be quickly released, removed, replaced and secured in place safely. In high voltage systems there are safety systems and redundancies that prevent a user from accidentally creating an unsafe condition. These systems are not designed for changing or exchanging batteries quickly. The physical mounting designs are engineered for permanently securing high voltage battery packs.

### SUMMARY OF THE INVENTION

An aspect of the present disclosure involves a hot swap battery carrier system having a cartridge design that allows a high voltage battery pack to be installed into a vehicle or equipment platform quickly. The cartridge is permanently installed in the vehicle and contains all the mechanical and safety elements required for proper release and installation of the battery pack. The hot swap battery carrier system allows a user to remove the high voltage battery pack without automated equipment.

The hot swap battery carrier system comprises a structural frame and mounting to attach to a vehicle, a slide mechanism that allows a high voltage battery pack to be completely installed and is electrically insulating, providing wear resistance and vibration dampening, and a quick retention mechanism including a latch assembly that secures the battery in place, and allows it to be released quickly.

Another aspect of the disclosure involves a hot swap battery carrier system comprising a receiver configured to be installed in a vehicle; a carrier including a battery pack; a slide mechanism configured to enable the carrier including the battery pack to slide into and out of the receiver.

One or more implementations of the aspect of the disclosure described immediately above includes one or more of the following: a quick retention mechanism configured to enable the carrier including the battery pack to be released without automated equipment; and/or the slide mechanism includes rails and slots operatively associated to allow the carrier including the battery pack to slide in and out of the receiver.

A further aspect of the disclosure involves a method of using a hot swap battery carrier system comprising providing a hot swap battery carrier system comprising a receiver configured to be installed in a vehicle; a carrier including a battery pack; a slide mechanism configured to enable the carrier including the battery pack to slide into and out of the receiver, and with the receiver installed in the vehicle; inserting the carrier with battery pack into the receiver in the vehicle and engaging the quick retention mechanism, securing the carrier with battery pack in place in the receiver.

One or more implementations of the aspect of the disclosure described immediately above includes one or more of the following: disengaging the quick retention mechanism and removing a carrier with battery pack to be replaced from the receiver in the vehicle prior to inserting the carrier with battery pack into the receiver; and/or a quick retention mechanism configured to enable the carrier including the battery pack to be released without automated equipment; and/or the slide mechanism includes rails and slots operatively associated to allow the carrier including the battery pack to slide in and out of the receiver.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is a front elevational view of an embodiment of a vehicle including an embodiment of a hot swap battery carrier system.

FIG. 2 is simplified front elevational view of an embodiment of a hot swap battery carrier system.

FIG. 3 is a flow chart of an exemplary method of using the hot swap battery carrier system of FIG. 2.

### DESCRIPTION OF EMBODIMENT OF THE INVENTION

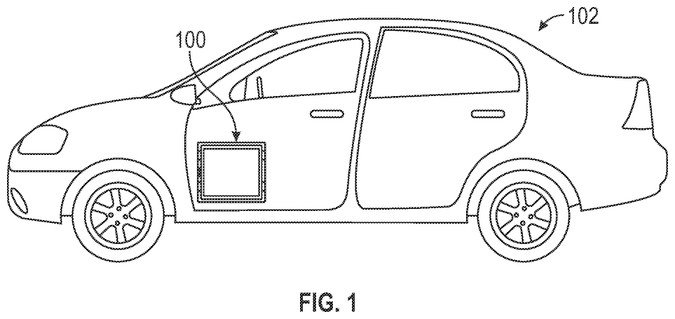

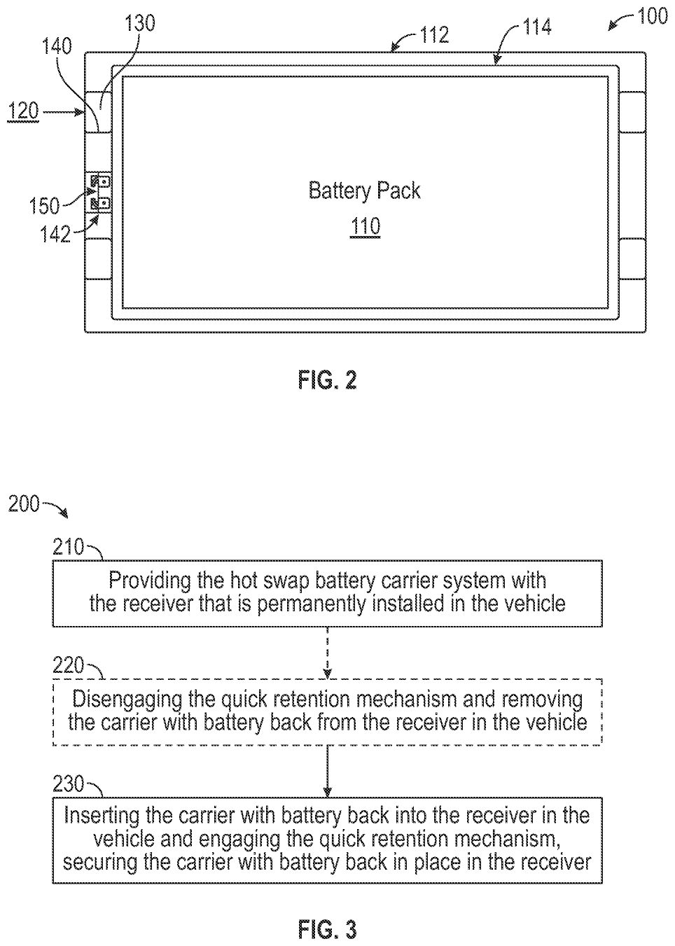

With reference to FIGS. 1 and 2, an embodiment of a hot swap battery carrier system 100 of a vehicle 102 (e.g., auto, truck, train, trolley, bus, off-road vehicle, boat) will be described. The hot swap battery carrier system 100 includes a cartridge design that allows a high voltage battery pack/battery (“battery pack”) 110 to be installed into and removed from the vehicle 102 or equipment platform quickly. The hot swap battery carrier system 100 includes a receiver 112 that is permanently installed in the vehicle 102 and contains all the mechanical and safety elements required for proper release and installation of a carrier 114 of the battery pack 110. The receiver 112 is a structural frame and mounting that attaches to the vehicle 102. A slide mechanism 120 (e.g., rails 130 of receiver 112 or carrier 114, slots 140 of carrier 114 or receiver 112) allows the carrier 114 with high voltage battery pack 110 to be completely installed within the receiver 114 and provides electrical insulation, wear resistance, and vibrational dampening. A quick retention mechanism 142 including a latch assembly 150 secures the carrier 114 with battery back 110 in place in the receiver 114, and allows the carrier 114 with battery pack 110 to be released quickly without automated equipment.

With reference to FIG. 3, a method 200 of using the hot swap battery carrier system 100 comprises, at step 210, providing the hot swap battery carrier system 100 with the receiver 112 installed in the vehicle 102; at optional step 220, disengaging the quick retention mechanism 142 and removing the carrier 114 with battery pack 110 from the receiver 112 in the vehicle 102, at step 230, inserting the carrier 114 with battery pack 110 into the receiver 112 in the vehicle 102 and engaging the quick retention mechanism 142, securing the carrier 114 with battery pack in place in the receiver 112.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I/We claim:

1. A hot swap battery carrier system, comprising:
a receiver configured to be installed in a vehicle;
a carrier including a battery pack;
a slide mechanism configured to enable the carrier including the battery pack to slide into and out of the receiver.

2. The hot swap battery carrier system of claim 1, further including a quick retention mechanism configured to enable the carrier including the battery pack to be released without automated equipment.

3. The hot swap battery carrier system of claim 1, wherein the slide mechanism includes rails and slots operatively associated to allow the carrier including the battery pack to slide in and out of the receiver.

4. A method of using a hot swap battery carrier system, comprising:
providing the hot swap battery carrier system of claim 2 with the receiver installed in the vehicle;
inserting the carrier with battery pack into the receiver in the vehicle and engaging the quick retention mechanism, securing the carrier with battery pack in place in the receiver.

5. The method of claim 4, further comprising disengaging the quick retention mechanism and removing a carrier with battery pack to be replaced from the receiver in the vehicle prior to inserting the carrier with battery pack into the receiver.
